(19) United States
(12) Patent Application Publication
(10) Pub. No.: US 2008/0173382 A1
(43) Pub. Date: Jul. 24, 2008

(54) SELF-HEALING MATERIALS AND USE THEREOF FOR EXTENDING THE LIFESPAN OF A TIRE

(76) Inventors: Thulasiram Gobinath, Hudson, OH (US); James Oral Hunt, Akron, OH (US); William Paul Francik, Akron, OH (US); Carl Trevor Ross Pulford, Akron, OH (US)

Correspondence Address: WOOD, HERRON & EVANS, LLP, 2700 CAREW TOWER, 441 VINE STREET, CINCINNATI, OH, 45202, US

(21) Appl. No.: 11/624,534

(22) Filed: Jan. 18, 2007

(51) Int. Cl. B29C 73/16; B29D 30/06

(52) U.S. Cl. 152/502; 264/328.3; 264/36.14

(57) ABSTRACT

The present invention is directed to self-healing materials and use thereof for extending the lifespan of a tire. The self-healing material includes a rubber healing agent, e.g., sulfur, encapsulated by a coating material, e.g., polypropylene, defining a microcapsule. The self-healing materials are processed with rubbery polymers to provide a rubber compound suitable for use in a tire. The microcapsule coating material is selected to prevent release of the healing agent during the processing steps of the rubber compound, such as can occur through melting or softening of the coating material, and to release the healing agent, e.g., via melting or softening, at a desired temperature greater than a tire's running temperature. Release of the healing agent can help repair damage to local polymeric structure, such as broken cross-links, by reacting with the surrounding rubber. In this way, that area of the rubber compound can be reinforced, thereby prolonging the life of the tire.

### FIELD OF THE INVENTION

The present invention is directed to self-healing materials and use thereof for extending the lifespan of a tire.

### BACKGROUND OF THE INVENTION

Tires are subjected to one of the harshest environments experienced by any consumer product. In addition to being stretched millions of times as they roll through their life, tires are exposed to acid rain, brake dust, harsh chemicals and direct sunlight, as well as summer's heat and winter's cold. In some cases, tires may develop cracks. Such cracks can initiate from within the tire, such as adjacent belt edges, as compared to on the surface of the tire. Generally, the edge of the second, or top, belt is the area of highest strain in a steel belted radial tire and it may also be a region with relatively less cord-to-rubber adhesion because bare steel can be exposed at the cut ends of the cords. If belt-edge separations have initiated, they may grow circumferentially and laterally along the edge of the second belt and can develop into cracks between the belts.

Poor tire maintenance practices (or other conditions) can increase the likelihood of developing cracks. For example, driving on a tire that is flat or a run flat tire under run flat conditions, or one that is underinflated or overloaded causes excessive stretching of the rubber compound, and may result in (or exacerbate) cracks.

In addition, simple exposure of tires to the elements can eventually cause rubber to lose some of its elasticity and allow surface cracking to appear. These cracks typically develop in the sidewalls or at the base of the tread grooves. Cracking can be accelerated by too much exposure to heat, vehicle exhaust, ozone and sunlight. Additionally, some sidewall cracking has been linked to abrasion from parking against a curb, or the excessive use of tire cleaners/dressings that inadvertently remove some of the tire's anti-oxidants and anti-ozonants protection during every cleaning procedure. Depending on their severity, they may be cosmetic in nature if they don't extend past the rubber's outer surface, or may be a reason to replace the tire if they reach deep into the rubber.

The repeated stretching of the rubber compound actually helps resist cracks forming. The tires used on vehicles that are driven infrequently, or accumulate low annual mileage are more likely to experience cracking because long periods of parking or storage interrupt “working” the rubber. In addition to being an annoyance to show car owners, this condition often frustrates motor home and recreational vehicle owners who only take occasional trips and cannot park their vehicle in a garage or shaded area. Using tire covers at least minimizes direct exposure to sunlight.

It would thus be desirable to provide a tire with an ability to repair its own cracks by repairing damage to the polymeric structure of the tire, thereby maintaining strength and durability, and extending the life of the tire.

### SUMMARY OF THE INVENTION

In accordance with an embodiment of the present invention, a self-healing material is provided for extending the lifespan of a tire. Such self-healing material may be compounded with a rubbery polymer and incorporated into a tire. To that end, the self-healing material may be provided dispersed, for example, in a rubber insert that is placed in an area of the tire that tends to age quicker than other areas, such as adjacent the belt edges. The rubber insert may be a run flat insert for use in a run flat tire. In another example, the self-healing material may be provided in a rubber compound for use as a tire tread or sidewall. Regardless, the self-healing material is ultimately situated within a desired area of the tire that generally is more susceptible to aging wherein the cross-links of the polymeric material in that area tend to break apart over time, which can lead to cracks in the tires, and subsequently cured to provide a finished tire. Breakdown of the polymeric material accelerates when tire temperatures run high.

The self-healing material of the present invention includes a rubber healing agent, such as a curing agent, e.g., sulfur, encapsulated by a coating material, such as a thermoplastic material, e.g., polypropylene, defining a microcapsule. The coating material of the microcapsule is selected to be thermally stable at the temperatures encountered during processing of the rubber compound, yet, selected to be thermally unstable at a desired tire operating temperature greater than those processing temperatures. Such processing can include mixing, calendaring, extrusion, and curing (or vulcanization) steps, for example. The tire's operating temperature where the coating material is thermally unstable is referred to herein as the healing temperature. At normal tire operating conditions, the tire is operating as designed such that the tire temperature is lower than the healing temperature. Accordingly, at the tire's healing temperature, the coating material releases the healing agent, e.g., via melting or softening, to repair damage to local polymeric structure, such as to repair broken cross-links, by reacting with the surrounding rubber, thereby mitigating tire wear and prolonging the life of the tire.

In another embodiment, the microcapsule may include a porous coating material. In one example, the coating material is provided with pores sized to allow release of the healing agent, at a desired rate, into the surrounding rubber of the assembled tire. The porosity of the microcapsule may be controlled by material selection. The porous material may optionally be thermally stable, rather than thermally unstable, at the tire operating temperatures greater than those temperatures encountered by the porous material during processing.

By virtue of the foregoing, there is thus provided self-healing materials and use thereof for extending the lifespan of a tire.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a cross-sectional view of a tire with self-healing material dispersed within a portion thereof in accordance with an embodiment of the present invention; and

FIG. 2 is an enlarged view of the in-circle portion 2 of FIG. 1 showing, in cross-section, the self-healing material in accordance with an embodiment of the present invention.

### DETAILED DESCRIPTION

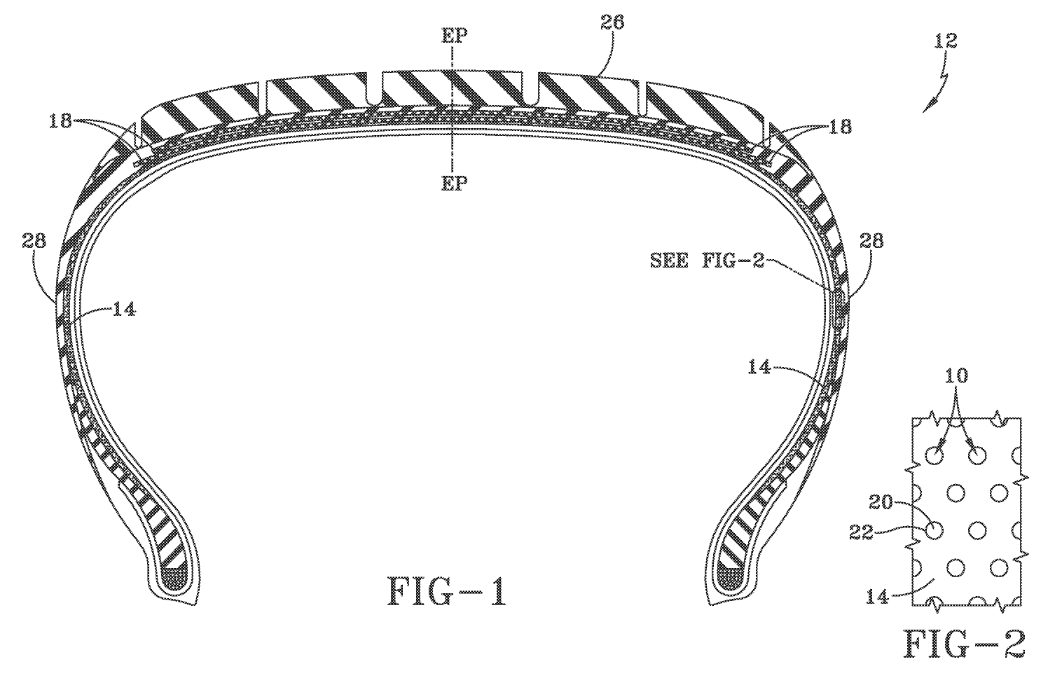

A self-healing material 10, as shown in FIGS. 1 and 2, is provided dispersed in a portion of a finished tire 12 and, more specifically, in a rubbery insert 14 of the tire 12, which is situated, in part, adjacent belts edges 18 so as to extend the lifespan of the tire 12, as further discussed below. The self-healing material 10 includes a rubber healing agent 20 encapsulated by a coating material defining a microcapsule 22. The rubbery insert 14, containing the self-healing material 10, generally can be formulated by means and methods known to those having ordinary skill in the art.

The rubber healing agents 20 that can be used may include, for example, curing agents or reversion resistant agents. Such healing agents 20 may be used alone or in mixtures. The curing agents, also known as vulcanizing agents and cross-linking agents, can include elemental sulfur (free sulfur) or sulfur donating vulcanizing agents, peroxides, or silane complexing agents, for example. Suitable sulfur donating compounds can include, for example, sulfur chloride, sulfur dichloride, morpholine disulfide, alkyl phenol disulfide, tetramethyl thiuram disulfide, selenium dimethyldithiocarbamate, high-molecular polysulfides, amine disulfides, polymeric polysulfides, alkyl phenol polysulfides, sulfur olefin adducts, dimorphylol disulphide (DTDM), 2-morpholino-dithiobenzothiazole (MBSS), tetramethylthiuram disulphide (TMTD), caprolactam disulphide, or dipenta-methylenethiuram disulphide. In the case of elemental sulfur, the form of sulfur is not particularly limited and can include, for example, powdered sulfur, precipitated sulfur, colloidal sulfur, surface-treated sulfur, or insoluble sulfur. In one embodiment, the curing agent is sulfur, which may be in a liquid form. In one example, liquid sulfur can include sulfur and a surfactant by which the sulfur is dispersed in water and/or an organic solvent. Suitable reversion resistant agents include, for example, N-N′-m phenylenediamaleimides available from Du Pont Performance Elastomers, 1,3-Bis citraconimidamethyl benzene, such as Perklink 900™ available from Flexsys, triacrylates, and hexamethylene bisthiosulfate disodium salt dihydrate, such as Duralink HTS™ also available from Flexsys.

Also contemplated as healing agents 20 are vulcanization accelerators. Suitable vulcanization accelerators include xanthates, dithiocarbamates, tetramethylthiuram disulphide and other thiurams, thiazoles, sulphenamides, such as benzothiazyl-2-cyclohexyl sulphenamide (CBS), benzothiazoyl-2-tert.-butyl sulphenamide (TBBS), guanidines, thiourea derivatives, and amine derivatives. Other suitable vulcanization accelerators are 2-mercaptobenzothiazole (MBT), zinc salt of 2-mercaptobenzothiazole (ZMBT), benzothiazyl-2-sulphene morpholide (MBS), benzothiazyldicyclohexyl sulphenamide (DCBS), diphenyl guanidine (DPG), diorthotolyl guanidine (DOTG), o-tolylbigaunide (OTBG), tetramethylthiuram monosulphide (TMTM), zinc-N-dimethyl-dithiocarbamate (ZDMC), zinc-N-diethyldithiocarbamate (ZDEC), zinc-N-dibutyl-dithiocarbamate (ZDBC), zinc-N-ethylphenyl-dithioc-arbamate (ZEBC), zinc-N-pentamethylene dithiocarbamate (ZPMC), ethylene thiourea (ETU), diethylthiourea (DETU), and diphenyl thiourea (DPTU). The accelerators are used mostly in combination with acceleration activators, which may include zinc oxide, antimony sulfide and litharge, and fatty acids such as stearic acid.

The coating material of the microcapsule 22 can be selected from a multitude of materials or mixtures thereof. For example, the coating may include waxes such as paraffins, resins such as phenol formaldehyde or urea formaldehyde, carbon pitches, thermoplastic elastomers such as Kraton™ and thermoplastics such as syndiotactic polybutadiene, polyethylene (PE), polyethylene oxide, polyvinyl acetate, ethylene-vinyl acetate copolymers, polyvinyl alcohols (PVA), polyacrylic acid and derivatives, polycarbonates, polymethylmethacrylate (PMMA), polyorthoester, polyvinylpyrrolidone, or polypropylene (PP). In one embodiment, the coating material is polypropylene. In another embodiment, the coating material is paraffin. In yet another embodiment, the coating material is urea formaldehyde.

Since the self-healing materials 10 are processed with rubbery polymers, as further discussed below, to ultimately provide a rubber compound, e.g., rubbery insert 14, a tire tread 26, and/or a sidewall 28, which is suitable for use in tire 12, the coating material selected must be able to withstand the processing temperatures. Such processing can include mixing, calendaring, extrusion, and curing (or vulcanization) steps, for example. Of the processing steps, vulcanization includes the highest temperature encountered by the coating material of the self-healing material 10, which may be from about 120° C. to about 150° C. depending on the characteristics of the tire 12 and tire rubber.

To that end, the coating material of the microcapsule 22 is chosen so as to be thermally stable at the temperatures it encounters during processing of the rubber compound, which includes curing, yet, selected to be thermally unstable at a desired tire operating temperature which is greater than those processing temperatures. As stated above, the tire's operating temperature where the coating material is thermally unstable is referred to herein as the healing temperature. Accordingly, the coating material for the microcapsule 22 is selected to both prevent release of the healing agent 20 during the processing steps, such as can occur through melting or softening of the coating material, and to release the healing agent 20, such as via melting or softening, at the healing temperature of the finished tire 12. This release can allow the healing agent 20 to repair damage to the local polymeric structure, such as broken cross-links, by reacting with the surrounding rubber. In this way, that area of the rubber compound can be reinforced, e.g., cross-linked, thereby prolonging the life of the tire 12. Depending upon the type of coating material used, the point at which the self-healing material becomes thermally unstable may be defined by its glass transition temperature rather than its melting point.

As already discussed, the healing temperature is greater than the processing temperatures encountered by the coating materials of the self-healing material 10. Such healing temperatures generally vary according to tire characteristics. In one example, off-the-road (OTR) tires generally have healing temperatures greater than about 130° C. In one embodiment, the healing temperature may be in the range of about 140° C. to about 180° C. In another example, passenger car tires generally may have a healing temperature greater than about 150° C. In one embodiment, the healing temperature may be in the range of about 160° C. to about 180° C. In yet another example, radial medium truck tires generally have healing temperatures greater than about 160° C. In one embodiment, the healing temperature may be in the range of about 170° C. to about 180° C. A defect in the tire 12, such as a crack in tire rubber adjacent belt edges 18 where broken cross-links in the polymeric structure may be found, can cause the tire 12 to reach its healing temperature as it runs along a surface. Such crack(s) may arise from tire underinflation, overloading, aging, etc. Accordingly, the healing temperature may be localized to one or more areas of the tire 12, e.g., adjacent a crack(s) in the rubber compound. In one embodiment, the coating material for the microcapsule 22 is polypropylene that melts at a healing temperature of about 140° C., which can be suitable for use in off-the-road (OTR) tires, for example.

The coating thickness of the microcapsule 22 also must provide enough durability for the self-healing material 10 to withstand the rigors of processing, such as mixing. As such, in one example, the coating thickness is about 18 nm to about 6000 nm thick. Also, the diameter of the microcapsules can vary widely but generally may be from about 1 micron to about 2000 microns. In one embodiment, the diameter is from about 10 micron to about 150 microns.

The self-healing material 10, in one embodiment, may also include multiple layers (not shown) of coating material. In one example, a first healing agent can be encapsulated by a first layer of coating material which is further encapsulated by another layer of coating material, with the first and second layers being separated by a second healing agent. Such multi-layered structure (not shown) can increase the lifespan of the self-healing material 10. The healing agents 20 may be the same or different. Similarly, the coating material may be the same or different. Different coating may melt or soften at different tire healing temperatures. In another embodiment, the microcapsule 22 may include a porous coating material, such as porous urea formaldehyde. In one example, the coating material is provided with pores sized to allow release of the healing agent 20, at a desired rate, into the surrounding rubber of the assembled tire 12. The porosity of the microcapsule 22 may be controlled by material selection. The porous material may optionally be thermally stable, rather than thermally unstable, at the tire operating temperatures greater than those temperatures encountered by the porous material during processing.

Microencapsulation techniques are known to those having ordinary skill in the art. To that end, the self-healing material 10 can be prepared in a variety of ways. One feature of the processes is that microcapsules 22 are formed completely encasing healing agents 20 to provide microcapsules 22 of the type and size described above. In one example, the microcapsule 22 is formed of a synthetic resin material, and may be produced by well-known polymerization methods, such as interfacial polymerization, in-situ polymerization or the like. In another example, the self-healing material 10 may be prepared by allowing a mixture, which contains healing agent, molten coating material, and optionally other auxiliaries such as surfactants or dispersants, to flow in a cooling column onto a rapidly rotating device such as a rotary table and migrate to the outside because of the high centrifugal force. Because the diameter is greater at the edge, the particles are separated and the formation of agglomerates avoided. After being flung off from the edge of the rotating device, the particles, or self-healing material 10, fly away to the outside individually and cool in the process, as a result of which the coating solidifies.

Other processes, such as spray-drying, fluidized-bed coating, emulsion or suspension processes and precipitation also come into consideration for the preparation of the self-healing material 10. In addition, multi-layered self-healing agents (not shown) may be produced by carrying out the coating steps several times in succession or else combining different preferred processes with one another.

As indicated above, the self-healing material 10 may be compounded with one or more natural and/or synthetic rubbery polymers, such as to provide rubbery insert 14 for use in tire 12. The rubber compound, which includes, for example, a rubbery polymer and self-healing material 10, may be compounded by methods generally known in the rubber compounding art, such as by mixing the various constituent materials. In one example, mixing can involve two successive preparation phases at temperatures in a range of from about 70° C. to about 160° C. to form a green rubber. The first step can define a non-productive stage, which may involve compounding of rubbery polymer and filler, for example, at temperatures up to about 160° C. The second step can define a productive stage wherein a curing agent, e.g., sulfur, and the self-healing material may be mixed into the first non-productive mix at temperatures up to about 130° C. to form a green rubber. The green rubber, with self-healing material 10, may be formed into a tire component, for example rubber insert 14, tire tread 26, and/or sidewall 28, and cured on tire 12 by means well known in the art, with curing temperatures that can range from about 120° C. to about 150° C., for example. Such processing may also generally include, for example, calendaring and extrusion as well as the mixing and vulcanization.

A typical rubber compound suitable for use in tire 12 can include, for example, (1) 50-100 phr natural rubber, synthetic rubber, or mixtures thereof, such rubbers may include dienic elastomers and/or vinyl aromatic elastomer (2) 0.1 phr to 60 phr filler (e.g., carbon black, silica, clay, etc.), (3) 0.1 phr to 10 phr curing agent (e.g. sulfur, peroxides, etc.), and (4) from 0.1 phr to 20 phr healing agent 20, which is encapsulated to define the self healing material 10. In one embodiment, the healing agent 20 is present in an amount of from about 1 phr to about 10 phr. In another embodiment, the self-healing material 10 includes sulfur that is encapsulated by polypropylene. The self-healing material 10 may be substantially evenly dispersed throughout the rubber compound or localized, as desired.

Accordingly, the rubbery insert 14 with self-healing material 10 generally may be incorporated at any desired location throughout the tire 12 or be confined to discrete areas of the tire 12, such as adjacent belt edges 18 or sidewall(s) 28. Although two are shown, it should be understood by one having ordinary skill in the art that more or less than two rubbery inserts 14 may be situated within the tire 12. And, as already indicated, the self-healing material 10 may be compounded directly into tire tread rubber 26 and/or sidewall 28, for example. In addition, it should be further understood that the tire may include self-healing materials 10 of different coatings and/or healing agents 20, as desired.

The self-healing material 10 ultimately is situated intact within a desired area of an assembled and cured tire, e.g., finished tire 12, that can be more susceptible to aging wherein the cross-links of the polymeric material in that area tend to break apart over time, which can lead to cracks in the tires and thus tire healing temperatures. The coating material of the self-healing material 10 can release the healing agent 20 such as through pores or by way of melting or softening when subjected to that healing temperature. After release, the healing agent 20 may repair damage to the local polymeric structure, such as broken cross-links, by reacting with the surrounding rubber. In this way, that area of the rubber compound can be reinforced, thereby prolonging the life of the tire 12.

A non-limiting example of the self-healing material 10, and use thereof, in accordance with the description are now disclosed below. This example is merely for the purpose of illustration and is not to be regarded as limiting the scope of the invention or the manner in which it can be practiced. Other examples will be appreciated by a person having ordinary skill in the art. Unless specifically indicated otherwise, parts and percentages are given by weight.

### EXAMPLE

Polypropylene, which melts at about 140° C., was heated and blended with a desired amount of sulfur in a twin-screw extruder so as to provide a 60% by weight mixture of sulfur in polypropylene. The mixture was allowed to cool then ground to produce particles of about 1000 μm in size. Although not specifically microencapsulated, this self-healing material, i.e., the particles, contained sulfur that was encapsulated by polypropylene. These particles were mixed and compounded with a standard rubber mix of (a) 100 parts by weight per hundred parts (phr) rubber; (b) 40-60 phr carbon black; (c) 0-30 phr oil; (d) 2-5 parts zinc oxide; (e) 1-3 part stearic acid; (f) 1-3 parts anti-oxidant (g) 1-5 phr sulfur; and (h) 0-5 phr ultra accelerator and accelerators. The compounding involved two successive preparation phases. The first phase or step defined a non-productive stage, which involved compounding of the rubber and filler at temperatures up to about 160° C. The second step defined a productive phase or step wherein the remaining ingredients, including the particles, were mixed into the first non-productive mix at temperatures not exceeding 125° C., then cured at about 130° C. The particles provided an additional 5.2 phr sulfur to the rubber compound. A control rubber compound of the same standard rubber mix, minus the particles, was also prepared.

The control and test compounds were subjected to torsional testing to determine the Dynamic storage modulus (G′). The control and test compounds exhibited a G′ modulus of about 7 and 8 (MPA), respectively. The compounds then were subjected to 160° C. for 40 minutes to “age” the compound and simulate a tire's healing temperature. Following “aging”, the compounds were subjected again to torsional testing. The test compound showed an improved G′ modulus of about 14 (MPA) which was about double that of the control compound, which showed a slightly improved modulus of about 8 (MPA). This is indicative of an improved lift and load carrying capacity of the test compound.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative product and method and illustrative examples shown and described. Accordingly, departures may be made from such details without departing from the scope of the general inventive concept.

What is claimed is:

1. A finished tire comprising:
a cured rubber compound including a rubbery polymer and a self-healing material dispersed therein, the self-healing material including a rubber healing agent encapsulated by a coating material defining a microcapsule, the coating material of the microcapsule being thermally stable at temperatures encountered by the coating material during processing of the rubber compound, which includes curing, yet, thermally unstable at a desired healing temperature of the tire which is greater than the processing temperatures.

2. The tire of claim 1 wherein the rubber healing agent is a curing agent or reversion resistant agent.

3. The tire of claim 1 wherein the coating material is a thermoplastic material or a wax.

4. The tire of claim 1 wherein the rubber healing agent is sulfur and the coating material is polypropylene.

5. The tire of claim 1 wherein the rubber healing agent is liquid sulfur and the coating material is paraffin.

6. The tire of claim 1 wherein the coating material is porous.

7. The tire of claim 6 wherein the porous coating material is urea formaldehyde.

8. The tire of claim 1 wherein the porous coating material is thermally stable at the desired healing temperature of the tire which is greater than the processing temperatures.

9. The tire of claim 1 wherein the desired healing temperature is greater than about 140° C.

10. The tire of claim 1 wherein the rubber compound defines a tire tread, an insert, and/or a sidewall.

11. A method for extending the lifespan of a tire comprising:
curing an assembled tire to define a finished tire, the finished tire comprising a cured rubber compound including a rubbery polymer and a self-healing material dispersed therein, the self-healing material including a rubber healing agent encapsulated by a coating material defining a microcapsule, the coating material of the microcapsule being thermally stable at temperatures encountered by the coating material during processing of the rubber compound, which includes curing, yet, thermally unstable at a desired healing temperature of the tire which is greater than those processing temperatures, so that the coating material releases the healing agent to react with surrounding rubber, thereby prolonging the life of the tire.

12. The method of claim 11 wherein the coating material melts or softens at the desired healing temperature greater than those processing temperatures to release the healing agent to react with surrounding rubber, thereby prolonging the life of the tire.

13. The method of claim 11 wherein the rubber healing agent is a curing agent or reversion resistant agent.

14. The method of claim 11 wherein the coating material is a thermoplastic material or a wax.

15. The method of claim 11 wherein the coating material is porous.

16. The method of claim 15 wherein the porous coating material is thermally stable at the desired healing temperature of the tire, which is greater than the processing temperatures.

17. The method of claim 11 wherein the desired healing temperature is greater than about 140° C.

18. The method of claim 11 wherein the rubber compound defines a tire tread, an insert, and/or a sidewall.

19. A method for extending the lifespan of a tire comprising:
providing an assembled and cured tire to define a finished tire, the finished tire comprising a cured rubber compound including a rubbery polymer and a self-healing material dispersed therein, the self-healing material including a rubber healing agent encapsulated by a coating material defining a microcapsule, the coating material of the microcapsule being thermally stable at temperatures encountered by the coating material during processing of the rubber compound, which includes curing, yet, thermally unstable at a desired healing temperature of the tire which is greater than those processing temperatures, so that the coating material releases the healing agent to react with surrounding rubber, thereby prolonging the life of the tire.
